(19) United States
(12) Patent Application Publication
(10) Pub. No.: US 2007/0289212 A1
(43) Pub. Date: Dec. 20, 2007

(54) Space saving vase

(75) Inventor: Cecilia M. Shein, Northfolk, VA (US)

Correspondence Address: WEISS & WEISS, Suite 251, 300 Old Country Road, Mineola, NY, 11501, US

(73) Assignee: Broadway Kleer-Guard Corp.

(21) Appl. No.: 11/448,397

(22) Filed: Jun. 7, 2006

(51) Int. Cl. A01G 9/02

(52) U.S. Cl. 47/65.8

(57) ABSTRACT

A vase made of a material that can be folded up and stored when not in use and when in use filled with water and able to hold flowers.

### FIELD OF INVENTION

The present invention relates to a vase made of a material that can be folded up and stored when not in use, reused and when in use filled with water and able to hold flowers.

### BACKGROUND OF INVENTION

When flowers are delivered to a person at work or on vacation usually they have no place to put the flowers. Usually that person will place the flowers in a glass or other temporary device, which is not suited for keeping the flowers. Further if one were to keep a glass vase out in an office or home it takes up unnecessary space. Even when stored a glass vase takes up space in a persons cabinet.

U.S. Pat. No. 4,910,913 relates to a paper vase and blank for forming the same. The blank is stored in a flat condition including folding lines and cuts to form a paper vase having a flat triangular bottom, tapered size and an irregular sculptured upper edge.

U.S. Pat. No. 5,005,760 relates to a flexible, pliable, retaining package for flowers and plants. The package is made of cardboard, and flowers and plants can be forwarded in it and can be displayed at delivery in this package in its partly folded out position, which functions as a vase or a flower pot, having a bottom, side planes and connecting flaps.

U.S. Pat. No. 5,572,826 relates to a collapsible container for holding a floral grouping in a vertical position. The container is constructed from a flexible material that comprises a body, an upper open end and closed lower end. A bonding material is disposed upon a portion of the outer surface of the closed base for enabling the container to be bondingly connected to a surface for supporting the floral grouping in a vertical position. The container is collapsible to a substantially flat position and expandable there from to an expanded form for receiving a portion of a floral grouping in the interior space. The closed base has a bonding material disposed on the outer surface for connecting to a surface.

U.S. Pat. No. 5,759,652 and 6,156,398 relate to an article forming system for a decorative flowerpot cover. The article includes a male die, a female die and a platform having a support surface and an opening extending through the support surface. The article has overlapping folds.

U.S. Pat. No. 6,061,955 relates to a collapsible flower vase assembly including pedestal base cork attachment. The assembly includes an elongate and sleeve shaped body, which defines a polygonal shape in cross section. Fold lines extend along a longitudinal length of the body and the body includes a first open end and a second open end. A cork attachment corresponds in shape to the cross sectional shape of the sleeve body and is biasingly engaged against the second open end of the sleeve body so that the interior of the body is watertight and the attachment provides a pedestal base. The sleeve shape body is capable of being outwardly expanded from a first folded position to a second unfolded position prior to the cork attachment being releasably secured.

U.S. Pat. No. 6,672,002 relates to a package for transporting and displaying bunches of fresh cut flowers. The lower portion of a funnel shaped shell overlies and matches the shape of the top portion of a vase which has the same funnel shape as the lower portion of the shell. The package is a leak proof and rigid vase.

U.S. Pat. No. 6,752,270 relates to a packaging for long stemmed flowers, which comprises at least one or more vases made of flexible or rigid material and means for positioning the vase or vases in one or more display tubes, which allow the stems of the flowers to pass through.

U.S. Pat. No. 7,036,271 and U.S. patent publication number 2005-0144841 relate to a vase made of thin foldable material having a wall, an upper opening and a lower bottom, and a foot.

U.S. patent publication number 2006-0026896 relates to a transportation and display assembly for floral bouquets and plants. The assembly includes a collapsible vase and optionally a water impermeable liner. The collapsible vase may be constructed from a single sheet of flexible material and includes suitable folds or cuts so that it can be manipulated from a flattened configuration to an operational configuration.

U.S. patent publication number 2004-0187382 relates to a foldable vase having upper and base portions of such plastic film layers as polyvinyl chloride spreadably openable from an initial flat configuration upon immersion in warm water and hardenable to a predetermined shape when thereafter filled with cold water.

### SUMMARY IF THE INVENTION

The present invention relates to a vase comprising: an upper portion; and a a base portion. The upper portion and base portion are comprised of a plastic film. The base opens flat against a surface. The vase is folded flat when not in use.

The present invention relates to a vase, which can be folded flat to be stored or filled with water to hold flowers. It is an object of the present invention for the vase to be made of a plastic material. It is an object of the present invention for the vase to be made of polyvinyl chloride. It is an object of the present invention for the vase when flat to be stored in a drawer or on a shelf. It is an object of the present invention for the vase to be different sizes. It is an object of the present invention for the vase to be different shapes. It is an object of the present invention for the vase to have increased lateral stability because of the increased lateral dimension of the bottom of the vase. It is an object of the present invention for the base to have a flat bottom construction. The flat bottom construction makes the inside of the vase much easier to clean and dry. It is an object of the present invention for the vase to have increased water capacity. It is an object of the present invention for the vase material to have a thickness of at least 0.5 millimeters polyvinyl chloride. It is an object of the present invention for the vases to be made of a material having a thickness from 0.5-0.75 mm in thickness.

It is an object of the present invention for the vase to be of different colors. It is an object of the present invention for the vase to comprise one solid sheet of material attached to a base. It is an object of the present invention for the vase to comprise four walls attached to a square or rectangular base bottom. It is an object of the present invention for the base to be in the shape of a square, rectangle, circle or triangle. It is an object of the present invention for the round vase to be of a two-piece construction. It is an object of the present invention for the vase to be in the shape of a heart. It is an object of the present invention for the vase to be in the shape of an animal. It is an object of the present invention to be in the shape of a number. It is an object of the present invention for the vase to be in the shape of a baby bottle. It is an object of the present invention for the material that makes up the vase to be printed on.

It is an object of the present invention for the vase to be reusable. It is an object of the present invention for the vase to be easily cleaned. It is an object of the present invention for the vase to be see-through. It is an object of the present invention for the vase to be portable. It is an object of the present invention for the vase to be non-breakable.

It is an object of the present invention for the vase to be filled with cold water. It is an object of the present invention for the vase to not need to be shaped.

### BRIEF DESCRIPTION OF THE DRAWINGS

FIG. 1 illustrates the base of a device of the present invention.

FIG. 2 illustrates the base of a device of the present invention.

FIG. 3 shows the device of the present invention in its open position.

FIG. 4 shows the device of the present invention having printing on it in its open position.

FIG. 5 shows the device of the present invention having printing on it in its open position.

FIG. 6 shows the device of the present invention filled with water and having flowers in it.

FIG. 7 shows the device of FIG. 3 in its closed and folded position.

FIG. 8 shows the device of FIG. 5 in its closed and folded position.

### DETAILED DESCRIPTION OF THE INVENTION

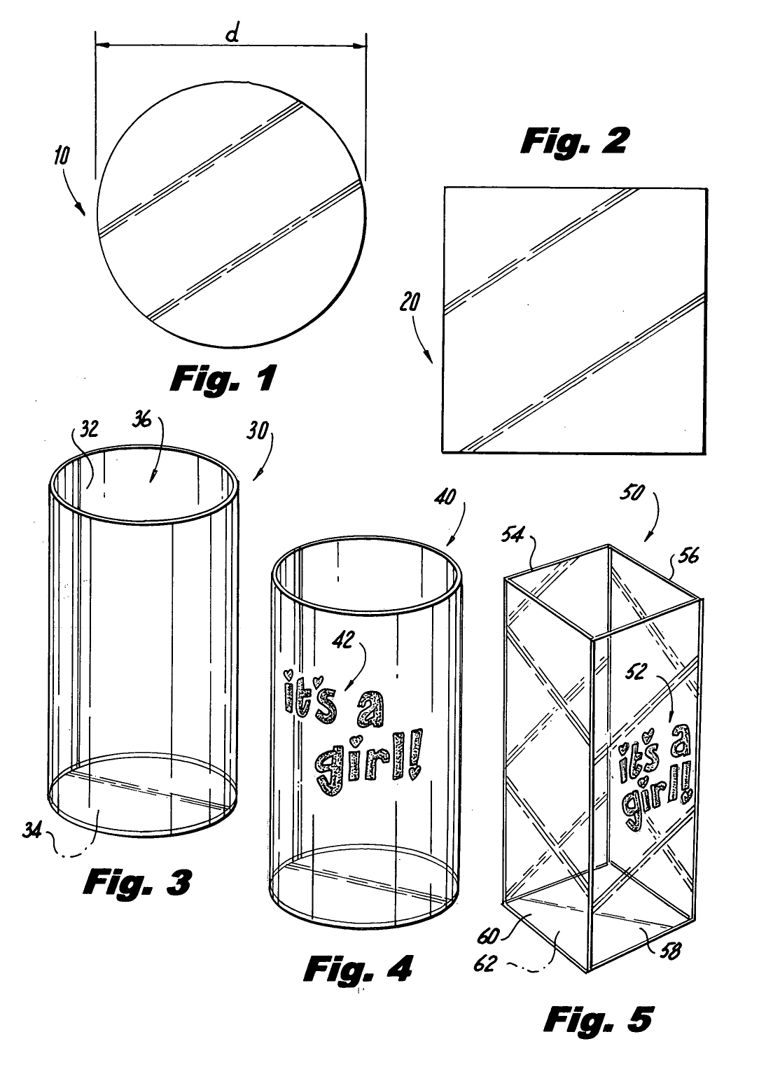

FIG. 1 shows the base 10 of a vase where in said base 10 is flat against a surface and shows an expanded diameter from those of the prior art. FIG. 2 shows a base 20 of a vase of the present invention wherein said base 20 has a square shape and fits flat against a surface. The surfaces can be a desktop, table, floor or any other flat surface. FIG. 3 shows a vase 30, which is comprised of a circular sheet of material 32 attached to a base 34. The vase 30 is watertight and can stand up right independently when partially filled with water. The vase in FIG. 3 shows a circular opening 36 on top.

FIG. 4 is a vase 40 similar to the vase of FIG. 3 having the same shape. Vase 40 has printing 42 on the outside surface or inside surface of the vase 40. FIG. 5 shows a vase 50 having printing 52, having four walls 54, 56, 58 and 60 and a base 62. The base 62 is attached to each of the walls and is in the shape of a square.

FIG. 6 shows a vase 70 containing water 72 and flowers 74.

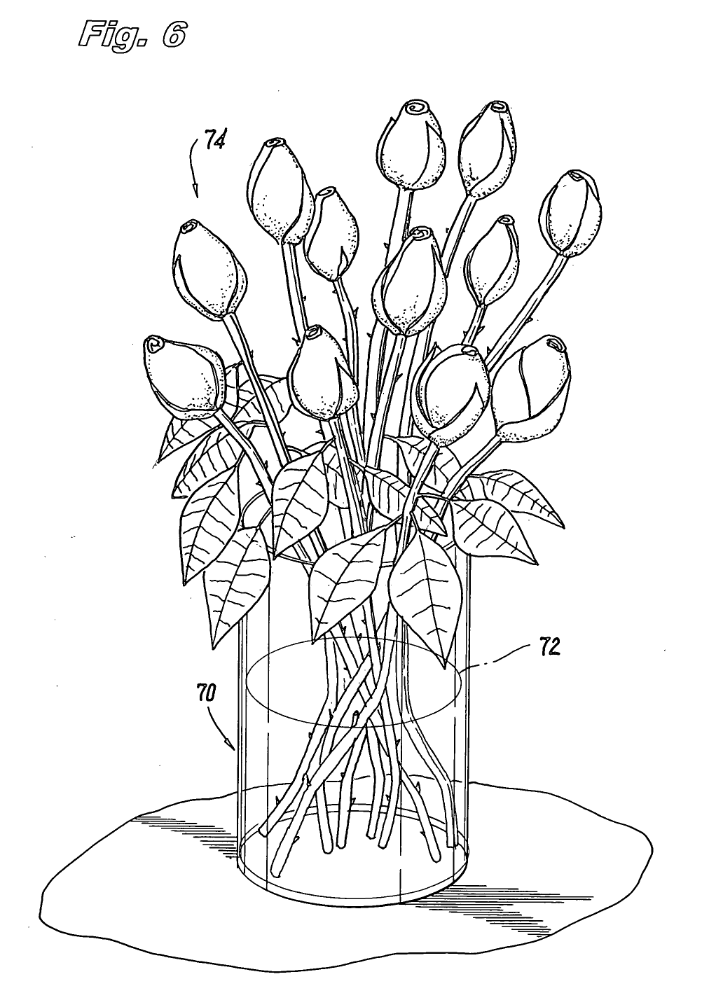

FIG. 7 shows the vase of FIG. 3 in its folded and flat position.

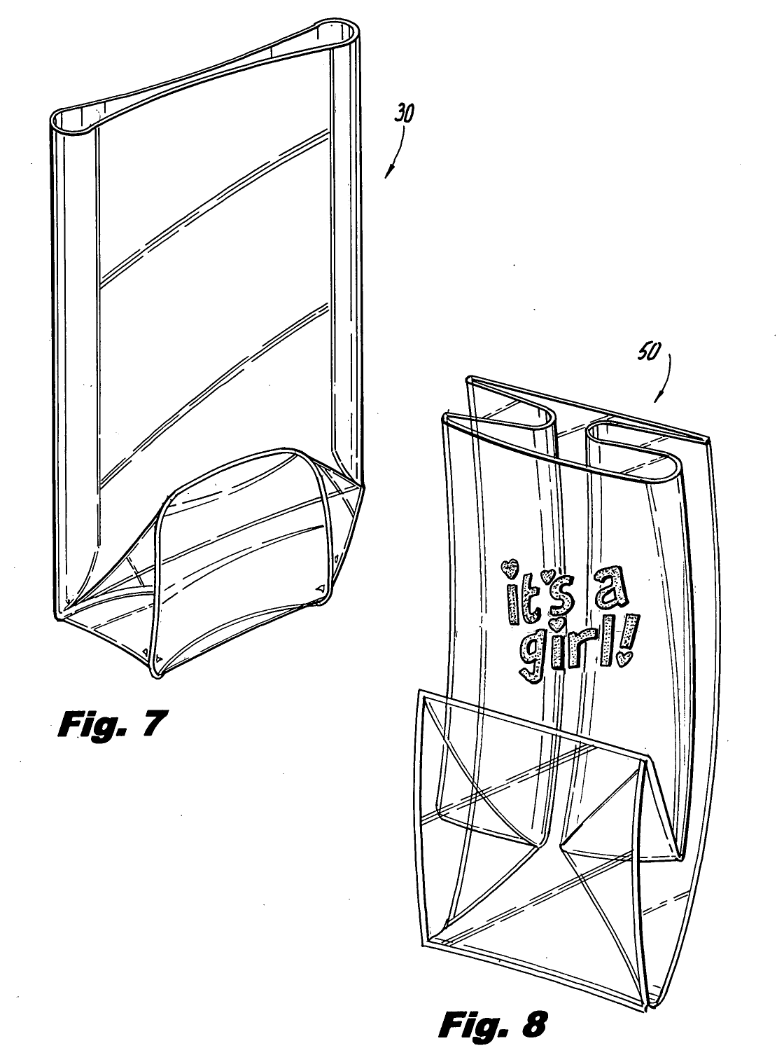

FIG. 8 shows the vase of FIG. 5 in its folded and flat position.

1. A vase comprising:
an upper portion;
a base portion;
said upper portion and said base portion comprising plastic film;
said base opens flat against a surface;
said vase being folded flat when not in use.

2. The vase of claim 1 wherein said vase comprises polyvinyl chloride.

3. The vase of claim 1 wherein said vase material has a thickness of at least 0.5 millimeters.

4. The vase of claim 1 wherein said upper portion is made of one solid sheet of material attached to a base.

5. The vase of claim 1 wherein said vase comprises four walls attached to a square or rectangular based bottom.

6. The vase of claim 1 wherein said vase is in the shape of a heart.

7. The vase of claim 1 wherein said vase is in the shape of an animal.

8. The vase of claim 1 wherein said vase is in the shape of a number.

9. The vase of claim 1 wherein said vase is in the shape of a baby bottle.

10. The vase of claim 1 wherein outer surface of said upper portion has printing on it.

11. The vase of claim 1 wherein inner surface of said upper portion has printing on it.

12. The vase of claim 1 wherein material of said vase is see-through.

13. The vase of claim 1 wherein said vase is leak proof.

14. The vase of claim 1 wherein said vase has increased lateral stability.
